(19) United States
(12) Patent Application Publication
(10) Pub. No.: US 2024/0024842 A1
(43) Pub. Date: Jan. 25, 2024

(54) METHOD FOR ACHIEVING HIGH GAS TEMPERATURES USING CENTRIFUGAL FORCE

(71) Applicants: Svetlana BECK, Berlin (DE); Valeri BECK, Berlin (DE)

(72) Inventor: Valeri BECK, Berlin (DE)

(21) Appl. No.: 18/255,492

(22) PCT Filed: Oct. 15, 2021
(86) PCT No.: PCT/DE2021/000172

§ 371 Date: Jun. 1, 2023

(30) Foreign Application Priority Data
Dec. 9, 2020 (DE) 10 2020 007 518.5

(51) Int. Cl. B01J 19/28; B01J 19/00

(52) U.S. Cl. CPC B01J 19/28; B01J 19/0013; B01J 2208/00371

(57) ABSTRACT

Many industrial processes take place often under high temperatures. One of the greatest problems is overheating of surrounding structural elements in contact with hot gases. This increases the thermal load on materials and reduces the service life of constructions. The construction of efficient cooling systems is very complex and time-consuming and presents a technical challenge. The invention addresses the problem of providing a method, which ensures separation of hot gases from construction walls while allowing high gas temperatures to be achieved in the working region. The problem is solved with a method, which is characterized in that a hot gas is kept in continuous rotation in a chamber, wherein the rotating gas forms a thermally insulating gas layer due to the effect of centrifugal force, and overheating of the chamber walls is avoided thereby. Using the invention can significantly reduce heat losses and thus energy consumption. Higher efficiencies can be achieved. According to the invention, construction materials which are more lightweight and cost-effective than conventional ones (e.g. aluminium alloys instead of heat-resistant steels) can advantageously be used. Costs for maintenance and operation can be significantly lowered by reducing heat losses.

The invention relates to a method for permanently achieving high gas temperatures and minimizing heat losses.

Many industrial processes and machines often run at high temperatures. One of the major problems with these processes is overheating of walls in contact with hot gases. Of great importance is also the thermal insulation of the gas ducts, the reduction of heat losses, as well as e.g. B. the cooling of turbine blades. An increase in the inlet temperatures in the gas and steam turbines causes an increase in the gas turbine efficiency on the one hand, but also requires a higher cooling air demand on the other hand, which in turn reduces the efficiency gain. Cooling gas turbines is a technical challenge that is particularly critical in aviation. Complex cooling methods such as impingement and film cooling, transpiration cooling, effusion cooling etc. are used in modern gas turbines, see for example patent specifications DE000069911600T2, EP000003179041A1, EP000001043480A2, EP000001149983A2, EP000003199759A1, DE000060307070T2, EP000003290639B1, EP000001914392A3, EP000001600608B1. The disadvantage of these cooling concepts is a very high level of complexity and therefore high costs and a higher overall construction weight.

Many chemical processes and reactions require high temperatures. In methane pyrolysis for example, a significant shift in the thermodynamic equilibrium in the direction of the reaction products is only possible above 800° C. (1 atm). At 1200° C., the theoretical efficiency of methane conversion is around 95% (doi:10.1088/1757-899X/228/1/012016), an approach to a 100% methane decomposition could only be reached in practice at above 2000° C. At high temperatures, however, the energy requirement increases enormously, which in turn reduces the overall efficiency of the chemical reactor considerably.

An example of a reactor for chemical reactions at high pressure and high temperature can be found in EP000002361675A1. A disadvantage of this reactor is that it has a complicated structure with a main reactor and a secondary reactor.

DE000002905206A1 describes a system for thermal water splitting in which concentrated sunlight is used to generate the reaction temperature above 1100° C. and a high-temperature reaction vessel is formed by electromagnetic fields. The disadvantage of this system is that such a reaction vessel can hardly be realized in practice.

Closest to the patented invention is a method for the rotational confinement of plasma disclosed in DE102009052623A1. The method relates to hot plasma maintenance but is not concerned with achieving high temperatures of non-ionized gases. The disadvantage of this method is that it requires a lot of energy because the plasma can only exist if there is a constant supply of energy.

The invention is based on the object of providing a method, which ensures that hot gases are separated from structural walls and, as a result, high gas temperatures can be achieved in a work area. The object is achieved with a method, which is characterized in that a hot gas or a gas mixture is kept rotating in a chamber, the rotating gas experiencing due to an exertion of a centrifugal force a separation of colder and therefore heavier and hotter and therefore lighter gas layers and thus a displacement of the hotter (lighter) gas in the center of rotation of the chamber and the colder (heavier) gas in the direction of the chamber wall takes place. Since gases have a very low thermal conductivity, the chamber walls are effectively separated from the hot gas masses in the center by a heat-insulating, colder gas layer, thus preventing the chamber walls from overheating. The walls of the chamber do not come into direct contact with hot gas, thereby advantageously reducing the contamination of reaction products by material from the walls.

The invention is illustrated schematically in drawings 1 to 5.

FIG. 1 shows an embodiment 1 with a rotating tube (1) with open ends (2), a gas (3) being introduced at one end of the tube and being heated in a manner known per se. The gas (3) (or the reaction products) flows out at the other end. Inside the tube (1), the gas is kept at a high temperature according to the invention and the tube walls thanks to the heat-insulating gas layer remain at a low temperature.

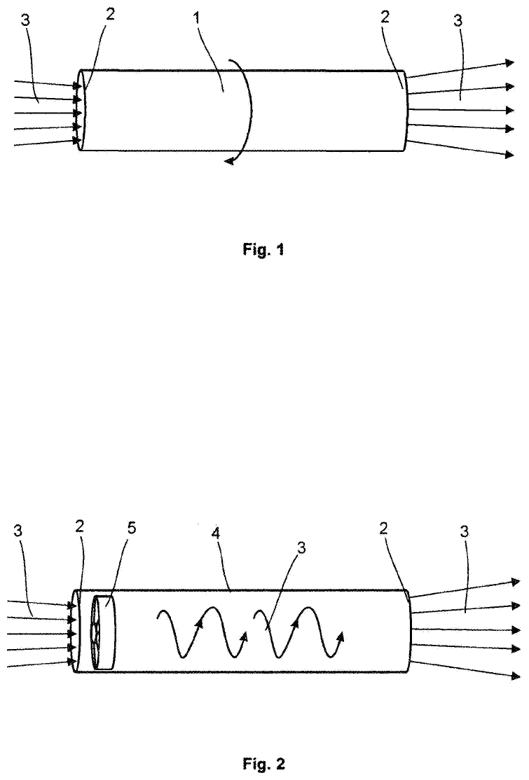

In FIG. 2 is shown an example 2 of the invention where the gas (3) is made to rotate in a non-rotating tube (4) by a bladed impeller or fan (5). The gas is heated as in Example 1 and separated from colder walls according to the invention.

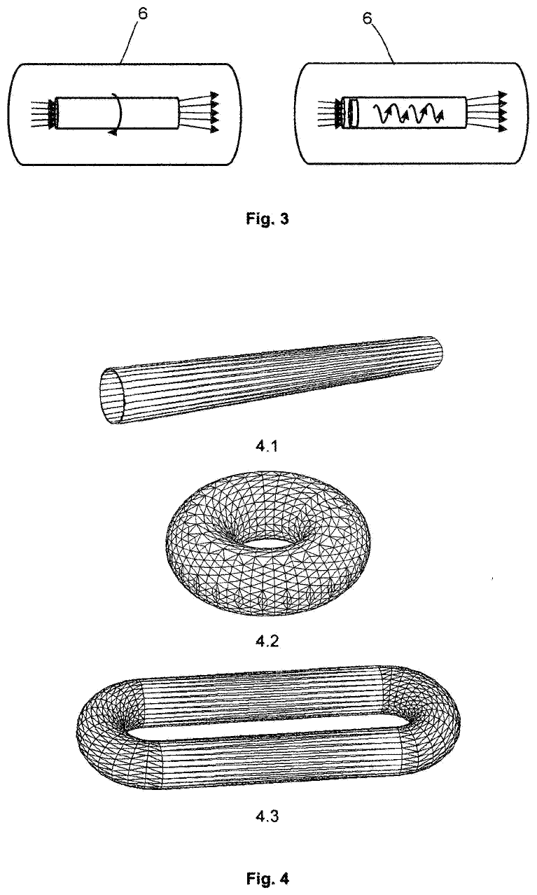

FIG. 3 depicts an example 3 for a closed container (6), the interior of the container (6) being under normal, negative or positive pressure. A gas (3) (or gaseous reagents) is kept at a high temperature in the container (6) according to embodiment 1 or 2, i.e. in a rotating tube (1) or in a non-rotating tube (4), according to the invention for intended work processes.

During rotary motion, the centrifugal force acts only in the radial direction, which means that the thermal insulation according to the invention does not function in the axial direction.

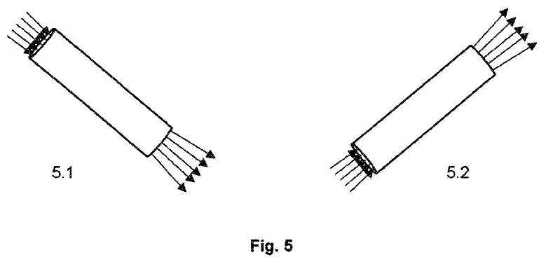

In order to minimize this disadvantage, the pipe length can be made significantly larger than the pipe diameter (e.g. in the ratio 10 to 1). This disadvantage cannot arise if a chamber is ring-shaped, such as a torus or two tubes connected at both ends, so that there are no free ends of the hot gas vortex. The embodiment 4 (FIG. 4) shows possible designs (4.1, 4.2, 4.3).

The chamber can be directed horizontally or with an inclination, see FIG. 5. If the exit end of the chamber is directed downwards (5.1), a separation of solid reaction products is facilitated by the action of earth's gravity. On the other hand, when oriented upwards (5.2), light gaseous products can escape better.

The proposed method was tested and successfully confirmed by the inventor in a series of experiments on a test facility. By using this method, heat losses and thus energy requirements can be significantly reduced. Higher efficiencies can be achieved. According to the invention, construction materials which are more lightweight and cost-effective than conventional ones (e.g. aluminium alloys instead of heat-resistant steels) can advantageously be used. Costs for maintenance and operation can be significantly lowered by reducing heat losses.

### REFERENCE LIST

1 rotating chamber
2 chamber end
3 gas
4 non-rotating chamber
4.1 embodiment 1
4.2 embodiment 2
4.3 embodiment 3
5 impeller with blades or fan
5.1 orientation downwards
5.2 orientation upwards
6 container

What is claimed is:

1. A method of spatially separating hot and cold gas products of a gas or gas mixture, the method comprising the steps of:
introducing a gas or gas mixture into a chamber,
heating the as or gas mixture in the chamber such that a hotter and thus lighter gas product and a colder and thus heavier gas product of the gas or as mixture are formed; and
rotating the gas or gas mixture in the chamber in such a way that, due to an acting centrifugal force, the hotter gas product is displaced in the direction of a center of rotation of the chamber and the colder gas product is displaced in the direction of a chamber wall of the chamber.

2. The method according to claim 1, wherein the rotation of the gas or gas mixture is achieved by setting the chamber in rotation.

3. The method according to claim 2, wherein the rotational speed of the chamber is set to at least 50 revolutions per minute.

4. The method according to claim 1, wherein the rotation of the gas or gas mixture in the chamber is achieved by at least one impeller with blades arranged in the chamber and/or by at least one fan arranged in the chamber and/or by gas flows.

5. The method according to claim 4, wherein the rotational speed of the impeller or the fan is set to at least 50 revolutions per minute.

6. The method according to of claim 1, wherein by spatially separating the hotter and colder gas products a temperature difference between a temperature of the chamber wall and a temperature in the center of rotation is between 140° C. and 2504° C.

7. The method according to claim 1, wherein by spatially separating the hotter and colder as products, a temperature difference between a temperature of the chamber wall and a temperature in the center of rotation is more than 2500° C.

8. The method according to claim 1, in which the chamber is oriented: horizontally; or with an angle of inclination of 0° to 90°; or with an angle of inclination of 0° to −90°.

9. The method according to claim 1, wherein the gas or gas mixture in the chamber contains methane, ethane, higher hydrocarbons, hydrogen sulfide, water vapor, ammonia and/or mixtures thereof

10. The method according to claim 1, wherein the chamber is arranged in a container and an interior space of the container is under normal pressure.

11. The method according to claim 1, wherein the chamber is arranged in a container and an interior space of the container is under negative pressure.

12. The method according to claim 1, wherein the chamber is arranged in a container and an interior space of the container is under positive pressure.

13. The method according to claim 1, wherein the chamber is tubular or ring-shaped.

14. The method according to claim 13, wherein a tube length of the tubular chamber is greater than a tube diameter of the tubular chamber.

15. An apparatus for spatially separating hot and cold gas products of a gas or gas mixture, the apparatus comprising:
a chamber into which the gas or gas mixture can be introduced;
a heating element arranged and configured to heat the gas or gas mixture introduced into the chamber such that a hotter and thus lighter gas product and a colder and thus heavier gas product of the gas or gas mixture are formed; and
a rotating element which is arranged and configured in such a way that the gas or gas mixture introduced into the chamber can be rotated in the chamber in such a way that, due to an acting centrifugal force, the hotter gas product is displaced in the direction of a center of rotation of the chamber and the colder gas product is displaced in the direction of a chamber wall of the chamber.

16. A use of the apparatus according to claim 15, for spatial separation of lighter gas products and heavy gas products obtained in particular from methane, ethane, higher hydrocarbons, hydrogen sulfide, steam, ammonia and/or mixtures thereof.
